(19) United States
(12) Patent Application Publication
(10) Pub. No.: US 2011/0006738 A1
(43) Pub. Date: Jan. 13, 2011

(54) ELECTROLYTE ADDITIVES FOR LITHIUM BATTERIES AND RELATED METHODS

(75) Inventors: Yuriy V. Mikhaylik, Tucson, AZ (US); Igor Kovalev, Vail, AZ (US)

Correspondence Address: WOLF GREENFIELD & SACKS, P.C., 600 ATLANTIC AVENUE, BOSTON, MA, 02210-2206, US

(73) Assignee: Sion Power Corporation

(21) Appl. No.: 12/679,371

(22) PCT Filed: Sep. 19, 2008
(86) PCT No.: PCT/US08/10894

§ 371 Date: Sep. 23, 2010

Related U.S. Application Data
(60) Provisional application No. 60/994,853, filed on Sep. 21, 2007.

(51) Int. Cl. H01M 10/056; H01M 10/058; H01M 4/58; H02J 7/00

(52) U.S. Cl. 320/134; 29/623.1; 429/206; 429/231.5

(57) ABSTRACT

The present invention relates generally to electrochemical cells, and more specifically, to additives for electrochemical cells which may enhance the performance of the cell. In some cases, the additive may advantageously reduce or prevent formation of impurities and/or depletion of active components of the cell during operation, to increase the efficiency and/or lifetime of the cell. The incorporation of certain additives within the electrolyte of the cell may improve the cycling lifetime and/or performance of the cell.

### FIELD OF THE INVENTION

The invention generally relates to electrochemical cells, additives for electrochemical cells, and related methods.

### BACKGROUND OF THE INVENTION

A typical electrochemical cell has a cathode and an anode which participate in an electrochemical reaction. Some electrochemical cells (e.g., rechargeable batteries) may undergo a charge/discharge cycle involving deposition of metal (e.g., lithium metal) on the surface of the anode and reaction of the metal on the anode surface to form metal ions, which diffuse from the anode surface into an electrolyte connecting the cathode with the anode. The efficiency and uniformity of such processes can be vital to efficient functioning of the electrochemical cell. In some cases, one or more electrodes may interact with the electrolyte as the electrochemical cell undergoes repeated charge/discharge cycles, generating various impurities which may deplete one or more electrochemically active species within the electrochemical cell (e.g., active electrolyte material). Formation of such impurities and/or depletion of the active materials can affect the quality of the electrolyte interface and can result in increasingly poor cell performance due to a high rate of electrolyte solvent depletion, poor electrode morphology, high capacity fade, particularly at early charge-discharge cycles, and increased cell polarization. While, in some cases, formation of the impurities and/or depletion of the active materials (e.g., electrodes, electrolyte) may eventually stabilize and/or become self-inhibiting, typically the active materials have already been depleted to the extent that cell performance is deteriorated.

Accordingly, improved electrochemical cells, devices, and methods are needed.

### SUMMARY OF THE INVENTION

The present invention provides methods for forming electrochemical cells comprising providing an anode comprising lithium, a cathode, and an electrolyte; and introducing into the electrolyte, from a source external to the cell, an additive having the formula LiR or (Li—X)ₙR′, wherein R comprises a heteroalkyl or heteroaryl group, optionally substituted; R′ comprises an alkyl or aryl group, optionally substituted, X is a heteroatom; and n is an integer equal to or greater than 1.

The present invention also relates to electrochemical cells comprising an anode comprising lithium; a cathode; and an electrolyte in electrochemical communication with the anode, the electrolyte comprising an external additive having the formula LiR or (Li—X)ₙR′, wherein R comprises a heteroalkyl or heteroaryl group, optionally substituted; R′ comprises an alkyl or aryl group, optionally substituted, X is a heteroatom; and n is an integer equal to or greater than 1.

The present invention also relates to devices comprising an electrochemical cell having been charged and discharged less than five times under set conditions, the cell comprising an anode comprising lithium; a cathode; and an electrolyte in electrochemical communication with the anode, the electrolyte comprising a lithium compound additive, wherein the lithium compound additive can be produced through reaction between the lithium of the anode and at least one other species of the cell during charge and/or discharge of the cell, which reaction is substantially irreversible under normal charge and/or discharge of the cell, and wherein the lithium compound is present in the cell in an amount greater than that formed through charge and discharge of the cell five times under the set conditions.

The present invention also relates to devices comprising an electrochemical cell having been charged and discharged less than five times in its lifetime, the cell comprising an anode comprising lithium; a cathode; and an electrolyte; wherein the anode comprises no more than five times the amount of lithium which can be ionized during one full discharge cycle of the cell.

The present invention also relates to devices comprising an electrochemical cell having been charged and discharged less than five times in its lifetime, the cell comprising an anode comprising lithium; a cathode; and an electrolyte layer; wherein the anode layer and the electrolyte layer together have a maximum thickness of 500 microns.

The present invention also provides methods of electrical energy storage and use of a device comprising providing an electrochemical cell having been charged and discharged less than five times in its lifetime, the cell comprising an anode comprising lithium, a cathode, and an electrolyte; and alternately discharging current from the cell to define an at least partially discharged cell, and at least partially charging said at least partially discharged cell to define an at least partially recharged cell, whereupon at least 20% of the lithium from the anode is reacted upon discharge in a reaction that is substantially reversible during normal cell charge and/or discharge.

The present invention also provides methods of electrical energy storage and use of a device comprising providing an electrochemical cell comprising an anode comprising lithium metal, a cathode, and an electrolyte; and alternately discharging and charging the cell through at least 25 cycles, wherein, in each of the at least 25 cycles, an essentially identical amount of lithium metal is depleted from the anode in each discharge cycle, and plated at the anode in each charge cycle.

The present invention also relates to devices comprising an electrochemical cell having been charged and discharged less than five times in its lifetime, the cell comprising an anode comprising lithium; a cathode active material; and an electrolyte; wherein the molar ratio of cathode active material to lithium is at least 0.1.

The present invention also relates to devices comprising an electrochemical cell having been charged and discharged less than five times in its lifetime, the cell comprising an anode comprising lithium; a cathode active material; and an electrolyte; wherein the ratio of cathode active material to lithium by weight is at least 0.46.

The present invention also relates to devices comprising an electrochemical cell having been charged and discharged less than five times in its lifetime, the cell comprising an anode comprising lithium; a cathode active material; and an electrolyte active material; wherein the ratio of cathode active material to electrolyte by weight is at least 0.17.

The present invention also relates to devices comprising an electrochemical cell having been charged and discharged less than five times in its lifetime, the cell comprising an anode comprising lithium; a cathode active material; and an electrolyte active material; wherein the ratio of cathode active material to lithium and electrolyte by weight is at least 0.16.

### BRIEF DESCRIPTION OF THE DRAWINGS

FIG. 1 shows an electrochemical cell, according to one embodiment of the invention.

FIG. 2 shows the formation of depletion products via (a) reaction of 1,2-dimethoxyethane and/or 1,3-dioxolane with lithium, (b) reaction of 1,2-dimethoxyethane and/or 1,3-dioxolane with a polysulfide, and (c) reaction of carbon disulfide with lithium-containing compounds to form impurities.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

The present invention relates generally to electrochemical cells, and more specifically, to additives for electrochemical cells. In particular, additives that may reduce or prevent formation of impurities and/or depletion of electrochemically active materials including electrodes and electrolyte materials, during charge/discharge of the electrochemical cell.

The present invention relates to the incorporation of additives into one or more components of an electrochemical cell, which may enhance the performance of the cell. In some cases, an additive such as an organometallic compound may be incorporated into the electrolyte and may reduce or prevent interaction between with at least two components or species of the cell to increase the efficiency and/or lifetime of the cell. Typically, electrochemical cells (e.g., rechargeable batteries) undergo a charge/discharge cycle involving deposition of metal (e.g., lithium metal) on the surface of the anode upon charging and reaction of the metal on the anode surface to form metal ions, upon discharging. The metal ions may diffuse from the anode surface into an electrolyte material connecting the cathode with the anode. The efficiency and uniformity of such processes may affect cell performance. For example, lithium metal may interact with one or more species of the electrolyte to substantially irreversibly form lithium-containing impurities, resulting in undesired depletion of one or more active components of the cell (e.g., lithium, electrolyte solvents). The incorporation of certain additives within the electrolyte of the cell have been found, in accordance with the invention, to reduce such interactions and to improve the cycling lifetime and/or performance of the cell.

One aspect of the invention is the discovery that certain additives, such as organometallic additives, may reduce or prevent formation of impurities, i.e., lithium-containing impurities, or other species that may be formed during charge-discharge cycling of the electrochemical cell. In some cases, formation of the impurities (e.g., depletion products) may advantageously be reduced and/or prevented while the cell is in early stages of operation, for example, when the cell has been charged and discharged less than five times in its lifetime. Incorporation of such additives within electrochemical devices may reduce formation of impurities and/or depletion of the electrodes, electrolyte, and/or other species present within the cell, and may improve overall cell performance. As used herein, the term “additive” or “external additive” refers to a material that may be incorporated within the cell from a source external to the cell, i.e., the “additive” does not refer to materials present within the cell, or materials that are produced, during charge or discharge, by interaction (e.g., chemical reaction) between species present within the cell. In some embodiments, the cells, devices, and methods described herein may exhibit improved performance including reduced capacity fade, improved morphology of electrodes (e.g., anode, cathode) upon cycling, reduced lithium corrosion with electrolyte components (e.g., polysulfides), reduced cell polarization, reduced depletion of electrolyte solvent, etc.

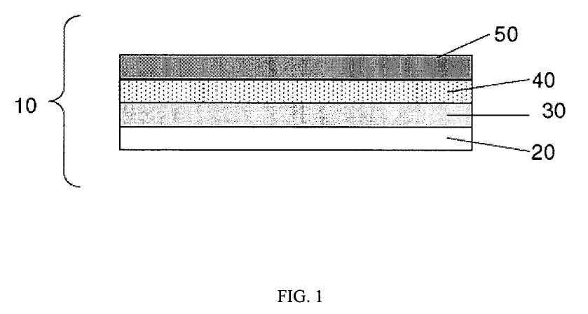

Although the present invention can find use in a wide variety of electrochemical devices, an example of one such device is provided in FIG. 1 for illustrative purposes only. In FIG. 1, a general embodiment of an electrochemical cell can include a cathode, an anode, and an electrolyte layer in contact with both electrodes. The components may be assembled such that the electrolyte is placed between the cathode and anode in a stacked configuration. FIG. 1 illustrates an electrochemical cell of the invention. In the embodiment shown, cell 10 includes a cathode 30 that can be formed on a substantially planar surface of substrate 20. A porous separator material 40 can be formed adjacent to the cathode 30 and can be deposited into the cathode 30. An anode layer 50 can be formed adjacent porous separator material 40 and may be in electrical communication with the cathode 30. The anode 50 may also be formed on an electrolyte layer positioned on cathode 30. Of course, the orientation of the components can be varied and it should be understood that there are other embodiments in which the orientation of the layers is varied such that, for example, the anode layer or the electrolyte layer is first formed on the substrate. Optionally, additional layers (not shown), such as a multi-layer structure that protects an electroactive material (e.g., an electrode) from the electrolyte, may be present, as described in more detail in U.S. patent application Ser. No. 11/400,781, filed Apr. 6, 2006, entitled, “Rechargeable Lithium/Water, Lithium/Air Batteries” to Affinito et al., which is incorporated herein by reference in its entirety. Additionally, non-planar arrangements, arrangements with proportions of materials different than those shown, and other alternative arrangements are useful in connection with the present invention. A typical electrochemical cell also would include, of course, current collectors, external circuitry, housing structure, and the like. Those of ordinary skill in the art are well aware of the many arrangements that can be utilized with the general schematic arrangement as shown in FIG. 1 and described herein.

As mentioned above, in some embodiments, the present invention relates to electrochemical devices comprising at least one additive. In some embodiments, the electrolyte may comprise the additive. However, other components of the electrochemical device may comprise the additive as well. In some embodiments, the present invention relates to electrochemical devices comprising an anode comprising lithium, a cathode, and an electrolyte (e.g., a non-aqueous electrolyte) comprising at least one additive. The additive may be any species, or salt thereof, capable of reducing or preventing the depletion of active materials (e.g., electrodes, electrolyte) within a cell, for example, by reducing formation of lithium-containing impurities within the cell, formed via reaction between lithium and an electrolyte material. In some embodiments, the additive may be an organic or organometallic compound, a polymer, salts thereof, or combinations thereof. In some embodiments, the additive may be a neutral species. In some embodiments, the additive may be a charged species. Additives of the invention may also be soluble with respect to one or more components of the cell (e.g., the electrolyte). In some cases, the additive may be an electrochemically active species. For example, the additive may be a lithium salt which may reduce or prevent depletion of lithium and/or the electrolyte, and may also serve as an electrochemically active lithium salt.

The additive may be present within (e.g., added to) the electrochemical cell in an amount sufficient to inhibit (e.g., reduce or prevent) formation of impurities and/or depletion of the active materials within the cell. “An amount sufficient to inhibit formation of impurities and/or depletion of the active materials within the cell,” in this context, means that the additive is present in a large enough amount to affect (e.g., reduce) formation of impurities and/or the depletion of the active materials, relative to an essentially identical cell lacking the additive. For example, trace amounts of an additive may not be sufficient to inhibit depletion of active materials in the cell. Those of ordinary skill in the art may determine whether an additive is present in an amount sufficient to affect depletion of active materials within an electrochemical device. For example, the additive may be incorporated within a component of an electrochemical cell, such as the electrolyte, and the electrochemical cell may be monitored over a number of charge/discharge cycles to observe any changes in the amount, thickness, or morphology of the electrodes or electrolyte, or any changes in cell performance. Determination of the amount of change in the active materials over a number of charge/discharge cycles may determine whether or not the additive is present in an amount sufficient to inhibit formation of impurities and/or depletion of the active materials. In some cases, the additive may be added to the electrochemical cell in an amount sufficient to inhibit formation of impurities and/or depletion of active materials in the cell by at least 50%, 60%, 70%, 80%, 90%, or, in some cases, by 100%, as compared to an essentially identical cell over an essentially identical set of charge/discharge cycles, absent the additive.

Although not wishing to be bound by any theory, the inventors of the present invention offer the following discussion of the relationship between the presence of the additive and performance characteristics observed. In typical lithium anode batteries, after a few charge/discharge cycles of a battery, adverse changes can occur, such as formation of impurities and/or depletion of active materials. This may be due to interaction of lithium, or a lithium-containing compound, with one or more species in the electrolyte to substantially irreversibly form an impurity, such as a lithium-containing impurity. In some cases, formation of the impurity may comprise interaction between lithium, or a lithium-containing compound, and a solvent present within the electrochemical cell, to produce the impurity. In some cases, lithium or a lithium-containing compound may react with a solvent comprising at least one carbon-heteroatom bond (e.g., C—O, C═O, C—S, C═S, C—N, C═N, etc.) to form the lithium-containing impurity. In some cases, a sulfur-containing material (e.g., sulfur, carbon disulfide, polysulfides, etc.) may interact with a solvent to form the lithium-containing impurity such as an alkyl polysulfide, carbon disulfide, polythiocarbonate, polythiocarboxylate, or the like.

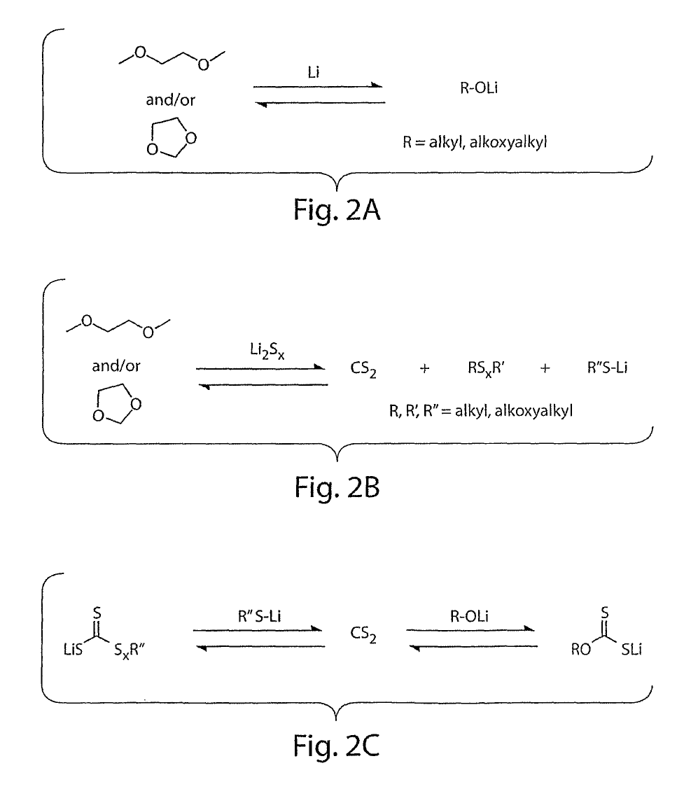

FIGS. 2A-C show some examples of reactions between lithium or lithium-containing compounds with one or more solvents present within the electrolyte to substantially irreversibly form impurities. FIG. 2A shows the reaction of 1,2-dimethoxyethane and/or 1,3-dioxolane with lithium to form an impurity. FIG. 2B shows the reaction of 1,2-dimethoxyethane and/or 1,3-dioxolane with a polysulfide (e.g., Li₂Sₓ) to form an impurity. FIG. 2C shows the reaction of carbon disulfide with lithium-containing compounds to form impurities.

The presence of additives of the invention within the cell may reduce and/or substantially inhibit formation of impurities, thereby reducing active material depletion and improving the performance and/or lifetime of the batteries. In some cases, the additive, incorporated within the cell from a source external to the cell, may have the same chemical structure as a compound (e.g., a depletion product) that may be formed as a result of a substantially irreversible reaction between lithium of the anode with one or more species present within the electrolyte, under normal charge and/or discharge of the cell. However, the external additive may not be the product of such a reaction. That is, the additive may have the same chemical structure as a “depletion product” of the cell, although the additive is produced from and/or provided by a source external to the cell. In some cases, the additive may be incorporated within an electrochemical cell prior to use of the cell. In some cases, the additive may be incorporated within an electrochemical cell having been charged and discharged less than five times under set conditions. As used herein, “set conditions” may comprise, for example, application of a particular voltage, temperature, pKa, solvent, chemical reagent, type of atmosphere (e.g., nitrogen, argon, oxygen, etc.), or the like, for a particular period of time.

In some cases, the additive may have the same chemical structure as a product of a reaction between lithium of the anode and a solvent within the electrolyte, such as an ester, ether, acetal, ketal, or the like. Examples of such solvents include, but are not limited to, 1,2-dimethoxyethane and 1,2-dioxolane.

In some cases, the additive may be an organometallic compound, including salts. In some cases, the additive is a lithium compound, such as a lithium salt. The additive (e.g., the external additive) may have the formula LiR or (Li—X)ₙR′, wherein R comprises a heteroalkyl or heteroaryl group, optionally substituted; R′ comprises an alkyl or aryl group, optionally substituted; X may be a heteroatom; and n may be an integer equal to or greater than 1. In some cases, R may be —O-alkyl, —O-aryl, —O-heteroaryl, —S-alkyl, —S-aryl, —S-heteroaryl, optionally substituted. In some cases, R may be —O-alkyl, —O-alkoxyalkyl, —S-alkyl, or —S-alkoxyalkyl. In some cases, R may comprise an alcohol or a carboxyl group. Examples of such additives include lithium 2-methoxyethoxide or lithium methoxide. In one set of embodiments, the additive is lithium methoxide.

In some cases, the additives described herein may be associated with a polymer. For example, the additives may be combined with a polymer molecule or may be bonded to a polymer molecule. In some cases, the additive may be a polymer. For example, the additive may have the formula, R′—(O—Li)ₙ, wherein R′ is alkyl or alkoxyalkyl.

Some embodiments of the invention may provide electrochemical cells, comprising an anode comprising lithium, a cathode, and an electrolyte in electrochemical communication with the anode, wherein the electrolyte comprises an external additive as described herein.

In some embodiments, the invention provides methods for forming electrochemical cells. For example, an anode comprising lithium as the active anode material, a cathode, and an electrolyte may be provided. The method may comprise introducing into the electrolyte, from a source external to the cell, an additive having the formula LiR or (Li—X)ₙR′, as described herein.

As described above, some embodiments of the invention relate to devices comprising an electrochemical cell having been charged and discharged less than five times under set conditions. The cell may comprise an anode comprising lithium, a cathode, and an electrolyte in electrochemical communication with the anode. The electrolyte may comprise a lithium compound additive, which, under normal charge and/or discharge of the cell, can be produced through a substantially irreversible reaction between the lithium of the anode and at least one other species of the cell during charge and/or discharge of the cell. However, in some cases, the lithium compound additive may be present in the cell in an amount greater than that formed through charge and discharge of the cell five times under the set conditions. That is, the lithium compound additive can be provided to the cell from a source external to the cell, in an amount greater than would be produced internally within the cell through five charge and discharge cycles.

One advantageous feature of the present invention may be to provide the additive within the electrochemical cell in an amount sufficient to reduce or prevent internal formation of impurities during charge and/or discharge. The additive may be introduced into the cell prior to depletion of active material(s) and/or deterioration of cell performance. In some cases, the additive is advantageously provided prior to use of the cell, or in the early stages of use of the cell (e.g., when the cell has been charged and discharged less than five times under set conditions). For example, the additive may have the same chemical formula as an impurity or depletion product of the electrochemical cell, such that introduction of the additive in an amount sufficient to saturate the electrochemical cell may reduce and/or prevent internal formation of the impurity. That is, the amount of electrolyte, lithium, depletion product, and/or other species present within the cell may affect the equilibrium of the reaction which can generate the depletion product, as shown in FIGS. 2A-C, for example, such that, addition of the depletion product in an amount sufficient to affect the equilibrium of the reaction (e.g., to drive the equilibrium in a direction which reduces formation of the impurity) may reduce or prevent formation of the depletion product.

Another advantageous feature of the invention relates to the incorporation of an additive as described herein within the electrochemical cell, wherein the additive is an electrochemically active species. For example, the additive can serve as electrolyte salt and can facilitate one or more processes during charge and/or discharge of the cell. In some cases, the additive may be substantially soluble or miscible with one or more components of the cell. In some cases, the additive may be a salt which is substantially soluble with respect to the electrolyte. Thus, in some cases, the additive may serve to reduce or prevent formation of impurities within the cell and/or depletion of the active materials, as well as facilitate the charge-discharge processes within the cell.

In some embodiments, the invention relates to the discovery that incorporation of additives as described herein may allow for the use of smaller amounts of lithium and/or electrolyte within an electrochemical cell, relative to the amounts used in essentially identical cells lacking the additive. As described above, cells lacking the additives described herein often generate lithium-containing impurities and undergo depletion of active materials (e.g., lithium, electrolyte) during charge-discharge cycles of the cell. In some cases, the reaction which generates the lithium-containing impurity may, after a number of charge-discharge cycles, stabilize and/or begin to self-inhibit such that substantially no additional active material becomes depleted and the cell may function with the remaining active materials. For cells lacking additives as described herein, this “stabilization” is often reached only after a substantial amount of active material has been consumed and cell performance has deteriorated. Therefore, in some cases, a relatively large amount of lithium and/or electrolyte has often been incorporated within cells to accommodate for loss of material during consumption of active materials, in order to preserve cell performance.

Accordingly, incorporation of additives as described herein may reduce and/or prevent depletion of active materials such that the inclusion of large amounts of lithium and/or electrolyte within the electrochemical cell may not be necessary. For example, the additive may be incorporated into a cell prior to use of the cell, or in an early stage in the lifetime of the cell (e.g., less than five charge-discharge cycles), such that little or substantially no depletion of active material may occur upon charging or discharging of the cell. By reducing and/or eliminating the need accommodate for active material loss during charge-discharge of the cell, relatively small amounts of lithium may be used to fabricate cells and devices as described herein. In some embodiments, the invention relates to devices comprising an electrochemical cell having been charged and discharged less than five times in its lifetime, wherein the cell comprises an anode comprising lithium, a cathode, and an electrolyte, wherein the anode comprises no more than five times the amount of lithium which can be ionized during one full discharge cycle of the cell. In some cases, the anode comprises no more than four, three, or two times the amount of lithium which can be ionized during one full discharge cycle of the cell.

In some cases, the present invention relates to devices comprising an electrochemical cell having been charged and discharged less than five times in its lifetime, wherein the cell comprises an anode comprising lithium, a cathode active material (e.g., sulfur), and an electrolyte, wherein the molar ratio of cathode active material to lithium may be at least 0.1. For example, a cell may comprise sulfur and lithium, wherein the molar ratio S:Li is equal to or greater than 0.1. In some cases, the molar ratio of cathode active material to lithium is at least 0.3, at least 0.5, at least 0.7,or greater. In some embodiments, the ratio of cathode active material to lithium by weight may be at least 0.46. For example, a cell may comprise sulfur and lithium, wherein the ratio S:Li by weight is equal to or greater than 0.46. In some cases, the ratio of cathode active material to lithium by weight is at least 0.5, at least 0.7, at least 0.9, or greater. In some embodiments, the ratio of cathode active material to electrolyte by weight is at least 0.17. In some cases, the ratio of cathode active material to lithium by weight is at least 0.2, at least 0.5, at least 0.7, or greater. As used herein, the “cathode active material” refers to any electrochemically active species associated with the cathode. For example, the cathode may comprise a sulfur-containing material, wherein sulfur is the cathode active material. Other examples of cathode active materials are described more fully below.

The use of smaller amounts of lithium and/or electrolyte materials may advantageously allow for electrochemical cells, or portions thereof, having decreased thickness. In some embodiments, the invention relates to devices comprising an electrochemical cell having been charged and discharged less than five times in its lifetime, wherein the cell comprises an anode comprising lithium, a cathode, and an electrolyte layer, and wherein the anode layer and the electrolyte layer together have a maximum thickness of 500 microns. In some cases, the anode layer and the electrolyte layer together have a maximum thickness of 400 microns, 300 microns, 200 microns, or, in some cases, 100 microns.

It may be advantageous, in some cases, for an electrochemical cell or device to have the ability to react a large amount of lithium metal upon discharge in a reaction that is substantially reversible during normal cell charge and/or discharge, i.e., the cell or device may have a large “depth of discharge.” Such substantially reversibly reactions may not include, for example, consumption of lithium metal in a substantially irreversible reaction to form an impurity. In some cases, electrochemical cells, devices, and methods comprising an additive as described herein may have the ability to react a greater amount of lithium metal upon discharge in a substantially reversible reaction, relative to essentially identical cells, devices, and methods lacking the additive, with little or essentially no deterioration of cell performance due to, for example, morphological changes at the electrode.

For example, in some embodiments, the present invention provides methods of electrical energy storage and use of a device, wherein the method may comprise providing an electrochemical cell having been charged and discharged less than five times in its lifetime, wherein the cell comprises an anode comprising lithium, a cathode, and an electrolyte. The method may further comprise alternately discharging current from the cell to define an at least partially discharged cell, and at least partially charging said at least partially discharged cell to define an at least partially recharged cell, whereupon at least 20% of the lithium from the anode is reacted upon discharge in a reaction that is substantially reversible during normal cell charge and/or discharge. In some cases, at least 30%, 50%, 70%, or, in some cases, at least 90%, of the lithium from the anode is reacted upon discharge in a reaction that is substantially reversible during normal cell charge and/or discharge.

In some cases, essentially 100% of the lithium from the anode is reacted upon discharge in a reaction that is substantially reversible during normal cell charge and/or discharge. For example, for a particular number of charge-discharge cycles, an essentially identical amount of lithium metal may be depleted from the anode in each discharge cycle, and plated at the anode in each charge cycle. Some methods of the invention may comprise providing an electrochemical cell comprising an anode comprising lithium metal, a cathode, and an electrolyte, and alternately discharging and charging the cell through at least 25 cycles, wherein, in each of the at least 25 cycles, an essentially identical amount of lithium metal is depleted from the anode in each discharge cycle, and plated at the anode in each charge cycle. In some cases, the 25 cycles define cycles 25-50 of the device. The method may further comprise introduction of an additive into the cell, from a source external to the cell. The additive may have the formula LiR or (Li—X)ₙR′, as described herein.

Suitable electroactive materials for use as cathode active materials in the cathode of the electrochemical cells of the invention include, but are not limited to, electroactive transition metal chalcogenides, electroactive conductive polymers, electroactive sulfur-containing materials, and combinations thereof As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Examples of conductive polymers include polypyrroles, polyanilines, and polyacetylenes.

In some embodiments, electroactive materials for use as cathode active materials in electrochemical cells described herein include electroactive sulfur-containing materials. “Electroactive sulfur-containing materials,” as used herein, relates to cathode active materials which comprise the element sulfur in any form, wherein the electrochemical activity involves the oxidation or reduction of sulfur atoms or moieties. The nature of the electroactive sulfur-containing materials useful in the practice of this invention may vary widely, as known in the art. For example, in one embodiment, the electroactive sulfur-containing material comprises elemental sulfur. In another embodiment, the electroactive sulfur-containing material comprises a mixture of elemental sulfur and a sulfur-containing polymer. Thus, suitable electroactive sulfur-containing materials may include, but are not limited to, elemental sulfur and organic materials comprising sulfur atoms and carbon atoms, which may or may not be polymeric. Suitable organic materials include those further comprising heteroatoms, conductive polymer segments, composites, and conductive polymers.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al. of the common assignee, and PCT Publication No. WO 99/33130. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al.

In one embodiment, an electroactive sulfur-containing material of a cathode active layer comprises greater than 50% by weight of sulfur. In another embodiment, the electroactive sulfur-containing material comprises greater than 75% by weight of sulfur. In yet another embodiment, the electroactive sulfur-containing material comprises greater than 90% by weight of sulfur.

The cathode active layers of the present invention may comprise from about 20 to 100% by weight of electroactive cathode materials (e.g., as measured after an appropriate amount of solvent has been removed from the cathode active layer and/or after the layer has been appropriately cured). In one embodiment, the amount of electroactive sulfur-containing material in the cathode active layer is in the range of 5-30% by weight of the cathode active layer. In another embodiment, the amount of electroactive sulfur-containing material in the cathode active layer is in the range of 20% to 90% by weight of the cathode active layer.

Non-limiting examples of suitable liquid media (e.g., solvents) for the preparation of cathodes (as well as other components of cells described herein) include aqueous liquids, non-aqueous liquids, and mixtures thereof. In some embodiments, liquids such as, for example, water, methanol, ethanol, isopropanol, propanol, butanol, tetrahydrofuran, dimethoxyethane, acetone, toluene, xylene, acetonitrile, cyclohexane, and mixtures thereof can be used. Of course, other suitable solvents can also be used as needed.

Positive electrode layers may be prepared by methods known in the art. For example, one suitable method comprises the steps of: (a) dispersing or suspending in a liquid medium the electroactive sulfur-containing material, as described herein; (b) optionally adding to the mixture of step (a) a conductive filler and/or binder; (c) mixing the composition resulting from step (b) to disperse the electroactive sulfur-containing material; (d) casting the composition resulting from step (c) onto a suitable substrate; and (e) removing some or all of the liquid from the composition resulting from step (d) to provide the cathode active layer.

Suitable negative electrode materials for anode active layers described herein include, but are not limited to, lithium metal such as lithium foil and lithium deposited onto a conductive substrate, and lithium alloys (e.g., lithium-aluminum alloys and lithium-tin alloys). While these are preferred negative electrode materials, the current collectors may also be used with other cell chemistries.

Methods for depositing a negative electrode material (e.g., an alkali metal anode such as lithium) onto a substrate may include methods such as thermal evaporation, sputtering, jet vapor deposition, and laser ablation. Alternatively, where the anode comprises a lithium foil, or a lithium foil and a substrate, these can be laminated together by a lamination process as known in the art to form an anode.

Positive and/or negative electrodes may optionally include one or more layers that interact favorably with a suitable electrolyte, such as those described in U.S. Provisional Application Ser. No. 60/872,939, filed Dec. 4, 2006 and entitled “Separation of Electrolytes,” by Mikhaylik et al., which is incorporated herein by reference in its entirety.

The electrolytes used in electrochemical or battery cells can function as a medium for the storage and transport of ions, and in the special case of solid electrolytes and gel electrolytes, these materials may additionally function as a separator between the anode and the cathode. Any liquid, solid, or gel material capable of storing and transporting ions may be used, so long as the material is electrochemically and chemically unreactive with respect to the anode and the cathode, and the material facilitates the transport of ions (e.g., lithium ions) between the anode and the cathode. The electrolyte is electronically non-conductive to prevent short circuiting between the anode and the cathode.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dorniney in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Heterogeneous electrolyte compositions that can be used in batteries described herein are described in U.S. Provisional Application Ser. No. 60/872,939, filed Dec. 4, 2006.

Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, cyclic ethers, glymes, polyethers, phosphate esters, siloxanes, dioxolanes, N-alkylpyrrolidones, substituted forms of the foregoing, and blends thereof. Fluorinated derivatives of the foregoing are also useful as liquid electrolyte solvents.

In some cases, aqueous solvents can be used as electrolytes for lithium cells. Aqueous solvents can include water, which can contain other components such as ionic salts. As noted above, in some embodiments, the electrolyte can include species such as lithium hydroxide, or other species rendering the electrolyte basic, so as to reduce the concentration of hydrogen ions in the electrolyte.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, 20-40%, between 60-70%, between 70-80%, between 80-90%, or between 90-95% of a heterogeneous electrolyte by volume.

In some embodiments, one or more solid polymers can be used to form an electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

Examples of ionic electrolyte salts for use in the electrolytes of the present invention include, but are not limited to, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂. Other electrolyte salts that may be useful include lithium polysulfides (Li₂Sₓ), and lithium salts of organic ionic polysulfides (LiSₓR)ₙ, where x is an integer from 1 to 20, n is an integer from 1 to 3, and R is an organic group, and those disclosed in U.S. Pat. No. 5,538,812 to Lee et al.

In some embodiments, electrochemical cells may further comprise a separator interposed between the cathode and anode. The separator may be a solid non-conductive or insulative material which separates or insulates the anode and the cathode from each other preventing short circuiting, and which permits the transport of ions between the anode and the cathode.

The pores of the separator may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A variety of separator materials are known in the art. Examples of suitable solid porous separator materials include, but are not limited to, polyolefins, such as, for example, polyethylenes and polypropylenes, glass fiber filter papers, and ceramic materials. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee. Solid electrolytes and gel electrolytes may also function as a separator in addition to their electrolyte function.

In the compounds and compositions of the invention, the term “alkyl” refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. The alkyl groups may be optionally substituted with additional groups, as described further below. In some embodiments, a straight chain or branched chain alkyl may have 30 or fewer carbon atoms in its backbone, and, in some cases, 20 or fewer. In some embodiments, a straight chain or branched chain alkyl has 12 or fewer carbon atoms in its backbone (e.g., C₁-C₁₂ for straight chain, C₃-C₁₂ for branched chain), 6 or fewer, or, 4 or fewer. In some embodiments, cycloalkyls may have from 3-10 carbon atoms in their ring structure, or 5, 6 or 7 carbons in the ring structure. Examples of alkyl groups include, but are not limited to, methyl, ethyl, propyl, isopropyl, cyclopropyl, butyl, isobutyl, tert-butyl, cyclobutyl, hexyl, cyclochexyl, and the like.

The term “heteroalkyl” refers to an alkyl group as described herein in which one or more carbon atoms is replaced by a heteroatom. Suitable heteroatoms include oxygen, sulfur, nitrogen, phosphorus, and the like. Examples of heteroalkyl groups include, but are not limited to, alkoxy, amino, thioester, and the like.

The terms “alkene” and “alkyne” refer to unsaturated aliphatic groups analogous in length and possible substitution to the alkyls described above, but that contain at least one double or triple bond respectively.

The terms “heteroalkenyl” and “heteroalkynyl” refer to unsaturated aliphatic groups analogous in length and possible substitution to the heteroalkyls described above, but that contain at least one double or triple bond respectively.

As used herein, the term “halogen” or “halide” designates —F, —Cl, —Br or —I.

The term “methyl” refers to the monovalent radical —CH₃, and the term “methoxy” refers to the monovalent radical —OCH₃.

The term “aromatic” is given its ordinary meaning in the art and refers to cyclic groups comprising a conjugated pi electron system.

The term “aryl” refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls. The aryl group may be optionally substituted, as described herein. “Carbocyclic aryl groups” refer to aryl groups wherein the ring atoms on the aromatic ring are carbon atoms. Carbocyclic aryl groups include monocyclic carbocyclic aryl groups and polycyclic or fused compounds (e.g., two or more adjacent ring atoms are common to two adjoining rings) such as naphthyl groups.

The terms “heteroaryl” refers to aryl groups comprising at least one heteroatom as a ring atom.

The term “heterocycle” refers to cyclic groups containing at least one heteroatom as a ring atom, in some cases, 1 to 3 heteroatoms as ring atoms, with the remainder of the ring atoms being carbon atoms. Suitable heteroatoms include oxygen, sulfur, nitrogen, phosphorus, and the like. In some cases, the heterocycle may be 3- to 10-membered ring structures, or 3- to 7-membered rings, whose ring structures include one to four heteroatoms. The term “heterocycle” may include heteroaryl groups, saturated heterocycles (e.g., cycloheteroalkyl) groups, or combinations thereof. The heterocycle may be a saturated molecule, or may comprise one or more double bonds. In some case, the heterocycle is a nitrogen heterocycle, wherein at least one ring comprises at least one nitrogen ring atom. The heterocycles may be fused to other rings to form a polycylic heterocycle. The heterocycle may also be fused to a spirocyclic group. In some cases, the heterocycle may be attached to a molecule (e.g., a polymer) via a nitrogen or a carbon atom in the ring.

Heterocycles include, for example, thiophene, benzothiophene, thianthrene, furan, tetrahydrofuran, pyran, isobenzofuran, chromene, xanthene, phenoxathiin, pyrrole, dihydropyrrole, pyrrolidine, imidazole, pyrazole, pyrazine, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, triazole, tetrazole, oxazole, isoxazole, thiazole, isothiazole, phenanthridine, acridine, pyrimidine, phenanthroline, phenazine, phenarsazine, phenothiazine, furazan, phenoxazine, pyrrolidine, oxolane, thiolane, oxazole, oxazine, piperidine, homopiperidine (hexamethyleneimine), piperazine (e.g., N-methyl piperazine), morpholine, lactones, lactams such as azetidinones and pyrrolidinones, sultams, sultones, other saturated and/or unsaturated derivatives thereof, and the like. The heterocyclic ring can be optionally substituted at one or more positions with such substituents as described herein.

The term “alkoxy” refers to the group, O-alkyl.

The term “alkoxyalkyl” refers to an alkyl group substituted with an alkoxy group. For example, “—CH₂CH₂—OCH₃” is an alkoxyalkyl group.

The terms “amine” and “amino” are art-recognized and refer to both unsubstituted and substituted amines, e.g., a moiety that can be represented by the general formula: N(R′)(R″)(R′″) wherein R′, R″, and R′″ each independently represent a group permitted by the rules of valence.

The terms “ortho” (or “o-”), “meta” (or “m-”) and “para” (or “p-”) apply to 1,2-, 1,3- and 1,4-disubstituted benzenes, respectively. For example, the names 1,2-dimethylbenzene, ortho-dimethylbenzene, and o-dimethylbenzene are synonymous.

As used herein, the term “substituted” is contemplated to include all permissible substituents of organic compounds, “permissible” being in the context of the chemical rules of valence known to those of ordinary skill in the art. It will be understood that “substituted” also includes that the substitution results in a stable compound, e.g., which does not spontaneously undergo transformation such as by rearrangement, cyclization, elimination, etc. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl” group must still comprise the phenyl moiety and can not be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, -carboxamido, acyloxy, aminoalkyl, alkylaminoaryl, alkylaryl, alkylaminoalkyl, alkoxyaryl, arylamino, aralkylamino, alkylsulfonyl, -carboxamidoalkylaryl, -carboxamidoaryl, hydroxyalkyl, haloalkyl, alkylaminoalkylcarboxy-, aminocarboxamidoalkyl-, cyano, alkoxyalkyl, perhaloalkyl, arylalkyloxyalkyl, and the like.

The figures that accompany this disclosure are schematic only, and illustrate a substantially flat battery arrangement. It is to be understood that any electrochemical cell arrangement can be constructed, employing the principles of the present invention, in any configuration. For example, additional configurations are described in U.S. patent application Ser. No. 11/400,025, filed Apr. 6, 2006, entitled, “Electrode Protection in both Aqueous and Non-Aqueous Electrochemical Cells, including Rechargeable Lithium Batteries,” to Affinito et al., which is incorporated herein by reference in its entirety.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

### Examples

### Example 1

This example describes a protocol for preparing an electrochemical cell comprising a Li—S anode and a sulfur cathode including a porous, polyolefin separator, according to one embodiment of the invention. The electrochemical cell was fabricated to contain a Li—S anode, a sulfur cathode, a porous separator, and an electrolyte.

To prepare the cathode, a mixture of 73 wt % of elemental sulfur, 16 wt % of a first conductive carbon pigment, PRINTEX® XE-2, 6 wt % of a second conductive pigment, Carbon Ketjen Black®, and 5 wt % of polyethylene powder dispersed in isopropanol was coated onto both sides of a 6 micron thick PET aluminized substrate with carbon containing primer layer. After drying the coated cathode active layer, the film was measured to have a thickness of about 100 microns, a length of 1549 mm, and a width of 6.83 mm. The sulfur surface loading was 1.58 mg/cm². The anode used was metallic Li foil, with a total anode thickness of 50 microns, a length of 1626 mm, and a width of 41.91 mm.

To prepare the electrolyte (Electrolyte 1), a mixture containing 4.0 wt % of lithium bis(trifluromethanesulfoneimide), 3.77 wt % lithium nitrate, 1 wt % guanidine nitrate, and 6.2 wt % Li₂S₈ were combined with 1,3-dioxolane and dimethoxyethane (1:1 weight ratio mixture). The porous separator used was 9 micron Tonen from Exxon Mobile. The above components were combined into a layered structure of cathode/separator/anode, which was wound and compressed (e.g., to form a jellyroll). Cathode and anode contacts were attached to the finished jellyroll by a metal-spray technique. The cells were then placed into soft multi-layer packages and were filled with 7.0 g of liquid electrolyte, upon which the cells were thermally sealed. The prismatic cell mass was measure to be about 15.5 g.

Discharge-charge cycling of the cells was performed at 500 mA/315 mA, respectively, with discharge cutoff at a voltage of 1.7V and charge cutoff of 2.5V. The cell capacity was about 2500 mAh. The cells were cycled at room temperature 80 times. Chemical analysis of the electrolyte components showed that ˜0.5 g of 1,2-dimethoxyethane was depleted, and two depletion products were identified, lithium 2-methoxyethoxide (Li—O—CH₂CH₂—OCH₃) and lithium methoxide (LiOCH₃).

### Example 2

Lithium 2-methoxyethoxide was prepared according to the following procedure, for use as an additive to electrochemical cells as described herein. 2-Methoxyethanol (0.2 mol) was added drop-wise to 0.2 mol of Li metal in 100 g of 1,3-dioxolane while stirring at 25-30° C. in an argon atmosphere. The mixture was stirred until the reaction was complete (˜24 h). The resulting mixture contained a solution of lithium 2-methoxyethoxide and a white powder precipitate, which was filtered through a glass filter in argon atmosphere. The concentration of lithium 2-methoxyethoxide was ˜2.0 M, which was used for further electrolyte formulations.

### Example 3

The influence of additives on the performance of electrochemical cells was studied by introducing additives into electrochemical cells and observing cell performance. The additives that were studied were lithium 2-methoxyethoxide and lithium methoxide. Lithium 2-Methoxyethoxide was prepared as described in Example 2. Lithium methoxide was purchased from Aldrich and used directly.

Electrochemical cells having different electrolyte additives were prepared. One cell was prepared with Electrolyte 1, which was prepared as described in Example 1. A second cell was prepared with Electrolyte 2, which contained Electrolyte 1 plus 7 wt % of lithium 2-methoxyethoxide. A third cell was prepared with Electrolyte 3, which was prepared by saturation of Electrolyte 1 with low soluble lithium methoxide. The saturation concentration was below 0.4 wt %. A fourth cell was prepared with Electrolyte 4, which was prepared by adding 0.4 wt % methanol to Electrolyte 1. After filling the cell, the methanol reacted with metallic lithium to form lithium methoxide. Electrolytes 1, 2, 3 and 4 were used to fill fresh cells as described above. The cells were discharged and charged as described in Example 1. In some cases, a 2.5 A×1 s discharge impulse was applied to the cell after the 5^{th} charge to measure polarization of the cell and to calculate the direct current impedance of the cell according to the formula:

Impedance=(OCV−Voltage at 2.5 A)/2.5 A.

Table 1 summarizes the data obtained from the cells. Cells containing lithium 2-methoxyethoxide (Electrolyte 2) exhibited decreased charge efficiency, lower capacity, faster capacity decay, and higher cell impedance. By contrast, cells containing low soluble lithium methoxide (Electrolytes 3 and 4) showed positive influence on rate capability and cycle life and was neutral relative to capacity and charge efficiency.

TABLE 1

| | | Cycles to | Impedance | |
|---|---|---|---|---|
| | Capacity at | 1900 mAh | at 2.5 A | Charge |
| | 5^{th} cycle | capacity | impulse | Efficiency |
| Electrolyte 1 | 2508 mAh | 35 | 0.216 Ohm | 99.7% |
| Electrolyte 2 | 2310 mAh | 28 | 0.525 Ohm | 98.4% |
| Electrolyte 3 | 2512 mAh | 43 | 0.165 Ohm | 99.3% |
| Electrolyte 4 | 2513 mAh | 49 | 0.158 Ohm | 99.4% |

What is claimed:

1. A method for forming an electrochemical cell, comprising:
providing an anode comprising lithium, a cathode, and an electrolyte; and
introducing into the electrolyte, from a source external to the cell, an additive having the formula LiR or (Li—X)ₙR′,
wherein
R comprises a heteroalkyl or heteroaryl group, optionally substituted;
R′ comprises an alkyl or aryl group, optionally substituted,
X is a heteroatom; and
n is an integer equal to or greater than 1.

2. A method as in claim 1, wherein R is —O-alkyl, —O-aryl, —O-heteroaryl, —S-alkyl, —S-aryl, —S-heteroaryl, optionally substituted.

3. A method as in claim 1, wherein R is —O-alkyl, —O-alkoxyalkyl, —S-alkyl, or —S-alkoxyalkyl.

4. A method as in claim 1, wherein R comprises an alcohol or a carboxyl group.

5. A method as in claim 1, wherein the additive is lithium methoxide.

6. A method as in claim 1, wherein the additive is R—(O—Li)ₓ, wherein R is alkyl or alkoxyalkyl.

7. A method as in claim 1, wherein the introducing comprises adding a compound having the formula, R—H, to the electrolyte, wherein R comprises a heteroalkyl or heteroaryl group, optionally substituted.

8. A method as in claim 7, wherein the compound is an alcohol or thiol.

9. An electrochemical cell, comprising:
an anode comprising lithium;
a cathode; and
an electrolyte in electrochemical communication with the anode, the electrolyte comprising an external additive having the formula LiR or (Li—X)ₙR′,
wherein
R comprises a heteroalkyl or heteroaryl group, optionally substituted;
R′ comprises an alkyl or aryl group, optionally substituted,
X is a heteroatom; and
n is an integer equal to or greater than 1.

10. An electrochemical cell as in claim 9, wherein the external additive is not the product of a reaction between the lithium of the anode and at least one other species of the cell during charge and/or discharge of the cell, which reaction is substantially irreversible under normal charge and/or discharge of the cell,

11. An electrochemical cell as in claim 9, wherein R is —O-alkyl, —O-aryl, —O-heteroaryl, —S-alkyl, —S-aryl, —S-heteroaryl, optionally substituted.

12. An electrochemical cell as in claim 9, wherein R is —O-alkyl, —O-alkoxyalkyl, —S-alkyl, or —S-alkoxyalkyl.

13. An electrochemical cell as in claim 9, wherein R comprises an alcohol or a carboxyl group.

14. An electrochemical cell as in claim 9, wherein the additive is lithium methoxide.

15. An electrochemical cell as in claim 9, wherein the additive is R—(O—Li)ₓ, wherein R is alkyl or alkoxyalkyl.

16. An electrochemical cell as in claim 9, wherein the introducing comprises adding a compound having the formula, R—H, to the electrolyte, wherein R comprises a heteroalkyl or heteroaryl group, optionally substituted.

17. An electrochemical cell as in claim 9, wherein the compound is an alcohol or thiol.

18. A device, comprising:
an electrochemical cell having been charged and discharged less than five times under set conditions, the cell comprising:
an anode comprising lithium;
a cathode; and
an electrolyte in electrochemical communication with the anode, the electrolyte comprising a lithium compound additive,
wherein the lithium compound additive can be produced through reaction between the lithium of the anode and at least one other species of the cell during charge and/or discharge of the cell, which reaction is substantially irreversible under normal charge and/or discharge of the cell,
and wherein the lithium compound is present in the cell in an amount greater than that formed through charge and discharge of the cell five times under the set conditions.

19. A device as in claim 18, wherein the lithium compound additive has the formula LiR or (Li—X)ₙR′,
wherein
R comprises a heteroalkyl or heteroaryl group, optionally substituted;
R′ comprises an alkyl or aryl group, optionally substituted,
X is a heteroatom; and
n is an integer equal to or greater than 1.

20. A device as in claim 19, wherein R is —O-alkyl, —O-aryl, —O-heteroaryl, —S-alkyl, —S-aryl, —S-heteroaryl, optionally substituted.

21. A device as in claim 19, wherein R is —O-alkyl, —O-alkoxyalkyl, —S-alkyl, or —S-alkoxyalkyl.

22. A device as in claim 19, wherein R comprises an alcohol or a carboxyl group.

23. A device as in claim 18, wherein the lithium compound additive is lithium 2-methoxyethoxide or lithium methoxide.

24. A device as in claim 18, wherein the lithium compound additive is R—(O—Li)ₓ, wherein R is alkyl or alkoxyalkyl.

25. A device, comprising:
an electrochemical cell having been charged and discharged less than five times in its lifetime, the cell comprising:
an anode comprising lithium;
a cathode; and
an electrolyte;
wherein the anode comprises no more than five times the amount of lithium which can be ionized during one full discharge cycle of the cell.

26. A device as in claim 25, wherein the anode comprises no more than four times the amount of lithium which can be ionized during one full discharge cycle of the cell.

27. A device as in claim 25, wherein the anode comprises no more than three times the amount of lithium which can be ionized during one full discharge cycle of the cell.

28. A device as in claim 25, wherein the anode comprises no more than two times the amount of lithium which can be ionized during one full discharge cycle of the cell.

29. A device, comprising:
an electrochemical cell having been charged and discharged less than five times in its lifetime, the cell comprising:
an anode comprising lithium;
a cathode; and
an electrolyte layer;
wherein the anode layer and the electrolyte layer together have a maximum thickness of 500 microns.

30. A device as in claim 1, wherein the anode layer and the electrolyte layer together have a maximum thickness of 400 microns.

31. A device as in claim 1, wherein the anode layer and the electrolyte layer together have a maximum thickness of 300 microns.

32. A device as in claim 1, wherein the anode layer and the electrolyte layer together have a maximum thickness of 200 microns.

33. A device as in claim 1, wherein the anode layer and the electrolyte layer together have a maximum thickness of 100 microns.

34. A method of electrical energy storage and use of a device, comprising:
providing an electrochemical cell having been charged and discharged less than five times in its lifetime, the cell comprising an anode comprising lithium, a cathode, and an electrolyte; and
alternately discharging current from the cell to define an at least partially discharged cell, and at least partially charging said at least partially discharged cell to define an at least partially recharged cell, whereupon at least 20% of the lithium from the anode is reacted upon discharge in a reaction that is substantially reversible during normal cell charge and/or discharge.

35. A method as in claim 34, whereupon at least 30% of the lithium from the anode is reacted upon discharge in a reaction that is substantially reversible during normal cell charge and/or discharge.

36. A method as in claim 34, whereupon at least 50% of the lithium from the anode is reacted upon discharge in a reaction that is substantially reversible during normal cell charge and/or discharge.

37. A method as in claim 34, whereupon at least 70% of the lithium from the anode is reacted upon discharge in a reaction that is substantially reversible during normal cell charge and/or discharge.

38. A method as in claim 34, whereupon at least 90% of the lithium from the anode is reacted upon discharge in a reaction that is substantially reversible during normal cell charge and/or discharge.

39. A method of electrical energy storage and use of a device, comprising:
providing an electrochemical cell comprising an anode comprising lithium metal, a cathode, and an electrolyte; and
alternately discharging and charging the cell through at least 25 cycles, wherein, in each of the at least 25 cycles, an essentially identical amount of lithium metal is depleted from the anode in each discharge cycle, and plated at the anode in each charge cycle.

40. A method as in claim 39, wherein the 25 cycles define cycles 25-50 of the device.

41. A method as in claim 39, further comprising introducing into the electrolyte, from a source external to the cell, an additive having the formula LiR or (Li—X)ₙR′,
R comprises a heteroalkyl or heteroaryl group, optionally substituted;
R′ comprises an alkyl or aryl group, optionally substituted,
X is a heteroatom; and
n is an integer equal to or greater than 1.

42. A method as in claim 41, wherein R is —O-alkyl, —O-aryl, —O-heteroaryl, —S-alkyl, —S-aryl, —S-heteroaryl, optionally substituted.

43. A method as in claim 41, wherein R is —O-alkyl, —O-alkoxyalkyl, —S-alkyl, or —S-alkoxyalkyl.

44. A method as in claim 41, wherein R comprises an alcohol or a carboxyl group.

45. A method as in claim 41, wherein the additive is lithium methoxide.

46. A method as in claim 41, wherein the additive is R—(O—Li)ₓ, wherein R is alkyl or alkoxyalkyl.

47. A method as in claim 41, wherein the introducing comprises adding a compound having the formula, R—H, to the electrolyte, wherein R comprises a heteroalkyl or heteroaryl group, optionally substituted.

48. A method as in claim 47, wherein the compound is an alcohol or thiol.

49. A device, comprising:
an electrochemical cell having been charged and discharged less than five times in its lifetime, the cell comprising:
an anode comprising lithium;
a cathode active material; and
an electrolyte;
wherein the molar ratio of cathode active material to lithium is at least 0.1.

50. A device, comprising:
an electrochemical cell having been charged and discharged less than five times in its lifetime, the cell comprising:
an anode comprising lithium;
a cathode active material; and
an electrolyte;
wherein the ratio of cathode active material to lithium by weight is at least 0.46.

51. A device, comprising:
an electrochemical cell having been charged and discharged less than five times in its lifetime, the cell comprising:
an anode comprising lithium;
a cathode active material; and
an electrolyte active material;
wherein the ratio of cathode active material to electrolyte by weight is at least 0.17.

52. A device, comprising:
an electrochemical cell having been charged and discharged less than five times in its lifetime, the cell comprising:
an anode comprising lithium;
a cathode active material; and
an electrolyte active material;
wherein the ratio of cathode active material to lithium and electrolyte by weight is at least 0.16.
